(19) United States
(12) Patent Application Publication
(10) Pub. No.: US 2008/0291156 A1
(43) Pub. Date: Nov. 27, 2008

(54) Sanitary User Interface

(76) Inventors: Paul H. Dietz, Hopkinton, MA (US); Darren Leigh, Somerville, MA (US); William S. Yerazunis, Acton, MA (US); Jonathan Westhues, Cambridge, MA (US); John C. Barnwell, III, Leominster, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/752,481

(22) Filed: May 23, 2007

(51) Int. Cl. G09G 5/00

(52) U.S. Cl. 345/156

(57) ABSTRACT

A user interface is configured to detect an attempt to touch a virtual button. The interface includes a first concave mirror facing a second concave mirror. The second concave mirror includes an aperture. A physical control button is arranged proximate to the first mirror and aligned such that an image of the control button in a form of a virtual button appears at the aperture. An attempt to touch the virtual button is detected, and feedback is generated at the virtual button in response to detecting the attempt to touch the virtual button by a user.

### FIELD OF THE INVENTION

This invention relates to human-machine interfaces, and more particularly to interfaces which are inherently sanitary, yet provide a user experience similar to conventional tactile interfaces.

### BACKGROUND OF THE INVENTION

Transmission of disease can occur when a person touches a surface that previously has been touched by someone carrying a disease. For example, when someone with influenza covers his mouth during a cough and then presses an elevator call button, people touching the button later are at risk of being infected. To prevent the spread of disease, it is desirable to minimize the number of surfaces that are touched by large numbers of people.

U.S. Pat. Nos. 6,377,238 and 7,054,045 describe holographic human-machine interfaces (HMI). Those interfaces use holography to generate floating images of control buttons. Sensors detect when a user attempts to touch a control button, and the system can react appropriately. In this manner, the user never actually contacts a surface and the system is inherently sanitary.

A major drawback of those interfaces is that they do not provide any tactile response at the control button itself. Users cannot feel the buttons that they are attempting to actuate. In '045, the feedback is provided via a visual and auditory signal, which is remote and not associated directly with the control button. This is less familiar and less satisfying than feedback directly at the button. The system described in '045 also requires an unfamiliar feedback channel that requires more cognitive processing on the part of the user. This may impede proper operation. Similarly, physical buttons typically move in when pressed. It would be highly desirable mimic this type of response.

Clearly, a human-machine interface which more closely exhibits the characteristics of conventional physical interfaces while also being inherently sanitary would be highly desirable.

### SUMMARY OF THE INVENTION

A user interface is configured to detect an attempt: to touch a control button that appears as a virtual button. The interface includes a first concave mirror facing a second concave mirror. The second concave mirror includes an aperture. A physical button is arranged proximate to the first mirror and arranged such that an image of the physical button (a “virtual button”) in the form of the physical button appears at the aperture. An attempt to touch the virtual button is detected and feedback is generated at the virtual button in response to detecting the attempt to touch the virtual button. This way, the feedback is provided directly at the place where the interface is being actuated, which simulates real world physical interface more realistically. The user senses feedback at the place of interaction with the interface. You see it, you touch it, and you sense it, even though there is nothing real there. This provides a sanitary user interface.

### BRIEF DESCRIPTION OF THE DRAWINGS

FIG. 1 is a side, cross-sectional view of a human-machine interface according to an embodiment of the invention; and

FIG. 2 is a front view of the interface of FIG. 1.

### DETAILED DESCRIPTION OF THE PREFERRED EMBODIMENT

The present invention is a sanitary human-machine interface (HMI) that can provide tactile feedback. In one embodiment, the tactile sensation is provided by a puff of air or some other, perhaps, sanitizing gas.

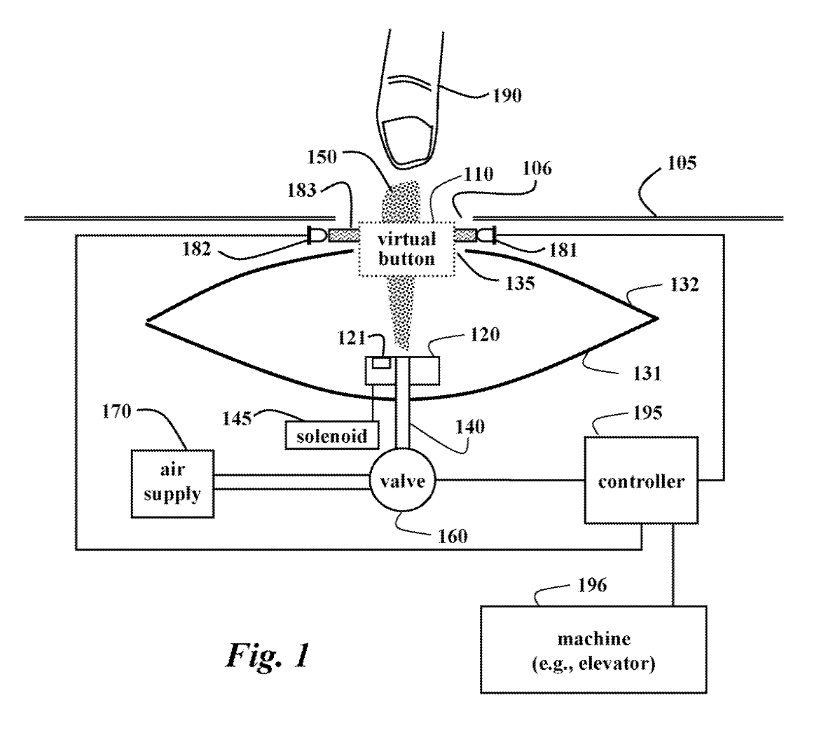

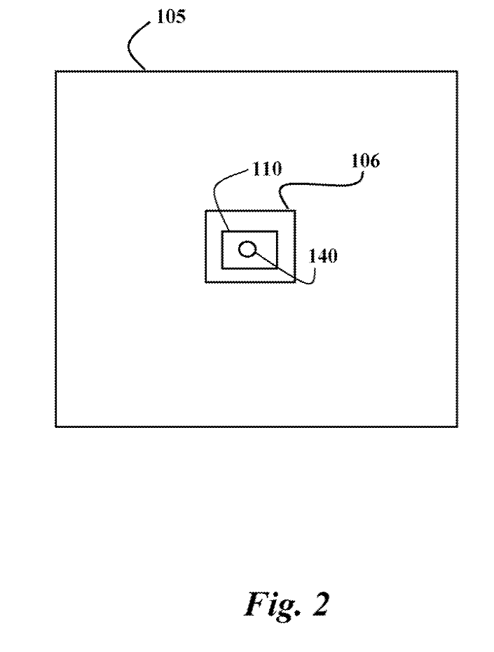

FIG. 1 shows a cross-sectional view of one embodiment of the invention. FIG. 2 is a frontal view. In this embodiment of the HMI, the HMI includes a single virtual control button 110 in a surface 105. If the button 110 is an elevator hall call button, then the surface 105 may be a wall. The surface includes a cut-out 106. The surface can also be part of a control panel of a machine.

The virtual button is a ‘floating’ image of a physical button 120. The image of the physical button 120 is generated by two inwardly facing concave mirrors 131-132, as described in U.S. Pat. No. 3,647,284, incorporated herein by reference. The location of the virtual button 110 is slightly dependent upon the angle of view. The virtual 110 button can be a different size than the physical button 120. The size depends on a degree of curvature of the concave mirrors 131-132.

The physical button 120 is placed proximate to the first mirror 131. The second opposing mirror has an aperture 135, e.g., a round hole. The physical button 120 is arranged so that the virtual button 110 appears at the aperture 135. The physical button 120 includes a tube 140 that supplies a burst of air 150, which creates a tactile sensation at the virtual button 110. The air flow 150 is turned on and off by a valve 160 connected to a sanitary, pressurized air supply 170. It is also possible to use gases other than air. For example, it may be desirable to use an easily stored aerosol, or a gas with a pleasant odor or disinfecting qualities.

The embodiments of the invention provide feedback directly at the place where the user interacts with the interface, without the user actually having direct physical contact with the interface. Thus, user experience is similar to a physical interface, where the touching provides feedback at the point of contact, i.e., the virtual button, without making any actual physical contact. This is in contrast with the prior art virtual controls where the feedback is disassociated with the contact point or place of interaction.

A light emitter 181 and a light detector 182, connected to a controller 195, are arranged so that a light beam 183 between the emitter 181 and detector 182 is interrupted when a finger 190 of a user attempts to touch the virtual button 110. The controller 195 can be connected to a machine 196, e.g., an elevator. To improve the accuracy of operations, multiple emitters and detectors can be used to provide multiple light beams. For example, the emitter/detector pairs can be placed so that two beams intersect at right angles. Mirrors can also be used to provide multiple light beams.

When an attempt to touch the virtual button 110 is detected, the controller 195 opens the valve 160, allowing the burst of air 150 to create the tactile sensation. The air can be momentarily pulsed or simply left on for the full duration of the attempt to touch the virtual button 110. In addition, the controller 195 can also move the physical button 120, either up and down, or sideways, when the attempt of touching occurs, using an actuator such as a solenoid 145. This way, the feedback appears to directly move the virtual button 110 as it is being touched.

In addition, the physical button 120 can include a light source 121, e.g., a LED, which turns on or changes in a detectable way, when the attempt of touching occurs. Additional visual and auditory feedback at the virtual button itself can be added to enhance the user experience.

While an interface that provides as many familiar cues as possible is optimal from a user experience point of view, expense or size constraints may restrict some interfaces to a subset of components. For example, an interface without tactile feedback but with a virtual button that appears to move in response to an attempted touch will still provide a significantly more satisfying experience to the user than the prior art. Similarly, an interface that does not provide the illusion of movement but does provide tactile feedback provides a distinct benefit over the prior art.

It should be noted that there are many options in the details of the implementation that fall within the spirit and scope of this invention. These variations include, but are not limited to, the following:

Alternatively, the means for generating the virtual button can include holograms or lenticular systems.

Alternative sensing techniques, e.g., capacitive, acoustic, microwave or other sensing techniques, can be used to sense the user interaction.

Alternative movement illusion can be provided. For example, a wide variety of actuators can be used to generate apparent movement of the virtual button in response to the touching. It is also possible to arrange the interface so that the puff of air physically drives the button movement.

The invention can also accommodate interface devices such as sliders. This can be implemented using a series of air jets to create force feedback over an extended area.

The invention can find application where the spread of disease may be an issue. Examples include elevators, call buttons, medical devices, etc., particularly in medical facilities.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. An apparatus for detecting an attempt to touch a virtual button and generating feedback to a user at the virtual button, comprising:
means for generating a virtual button, where the virtual button is an image of a control button;
means for detecting an attempt to touch the virtual button by a user; and
means for generating feedback to the user directly at the virtual button when the attempt to touch the virtual button by the user is detected.

2. The apparatus of claim 1, in which the virtual button appears near a surface.

3. The apparatus of claim 2, in which the surface is a wall, and the virtual button appears as an elevator hall call button.

4. The apparatus of claim 2, in which the surface is part of a control panel.

5. The apparatus of claim 1, in which the means for detecting is coupled to a machine.

6. The apparatus of claim 1, in which the means for detecting includes a light emitter and a light detector for generating a light beam which is interrupted when the attempt to touch occurs.

7. The apparatus of claim 1, in which the feedback is in a form of a burst of air at the virtual button.

8. The apparatus of claim 7, in which the burst of air has disinfecting qualities.

9. The apparatus of claim 1, in which the feedback includes visual and auditory feedback at the virtual button.

10. The apparatus of claim 6, in which the means for detecting includes multiple light beams.

11. The apparatus of claim 1, further comprising:
means for moving the virtual button in response to detecting the attempt to touch the virtual button.

12. The apparatus of claim 1, in which an appearance of the virtual button changes in response to detecting the attempt to touch the virtual button by the user.

13. The apparatus of claim 12, in which the virtual button changes in size in response to detecting the attempt to touch the virtual button.

14. The apparatus of claim 1, in which the means for detecting uses capacitive coupling.

15. The apparatus of claim 1, in which the means for detecting uses acoustic signals.

16. The apparatus of claim 1, in which the means for generating further comprises;
a first concave mirror;
a second concave mirror facing the first concave mirror, the second concave mirror including an aperture; and
a physical button arranged proximate to the first mirror and arranged such that an virtual button appears at the aperture, where the virtual button is an image of the physical button.

17. The apparatus of claim 1, in which the means for generating includes a hologram generator.

18. The apparatus of claim 1, in which the means for generating includes a lenticular lens system.

19. A method for detecting an attempt to touch a virtual button and generating feedback at the virtual button, comprising:
generating a virtual button, where the virtual button is an image of a control button;
detecting an attempt to touch the virtual button by a user; and
generating feedback to the user directly at the virtual button when the attempt to touch the virtual button is detected.
